(19) United States
(12) Patent Application Publication
(10) Pub. No.: US 2018/0281903 A1
(43) Pub. Date: Oct. 4, 2018

(54) GLAZING UNIT FOR UNDERWATER OBJECTS

(71) Applicant: PROTEH GLASSDEEP SPO&#321.KA Z.O.O., GDAŃSK (PL)

(72) Inventors: Eugeniusz ZIÓ&#321;KOWSKI, GDAŃSK (PL); Bogus&#322;aw SZAREJKO, GDYNIA (PL)

(21) Appl. No.: 15/762,890

(22) PCT Filed: Jul. 27, 2015
(86) PCT No.: PCT/PL2015/000123

§ 371 Date: Mar. 23, 2018

(51) Int. Cl. B63B 19/02

(52) U.S. Cl. CPC B63B 19/02; B32B 17/10321

(57) ABSTRACT

Glazing unit for underwater objects windows consisting of panes of mineral glass placed in circumferential clamp ring and on borders between panes of mineral glass have circumferential spacers, which have sealing in contact area with pane of mineral glass, characterized in that, glazing unit have at least two panes of mineral glass (1) separated by a layer of low compressible liquid (2) while constructed set of panes of mineral glass (1) with circumferential spacers (3) and sealing (4) are border with circumferential seal (5) clamped by circumferential clamp ring (6).

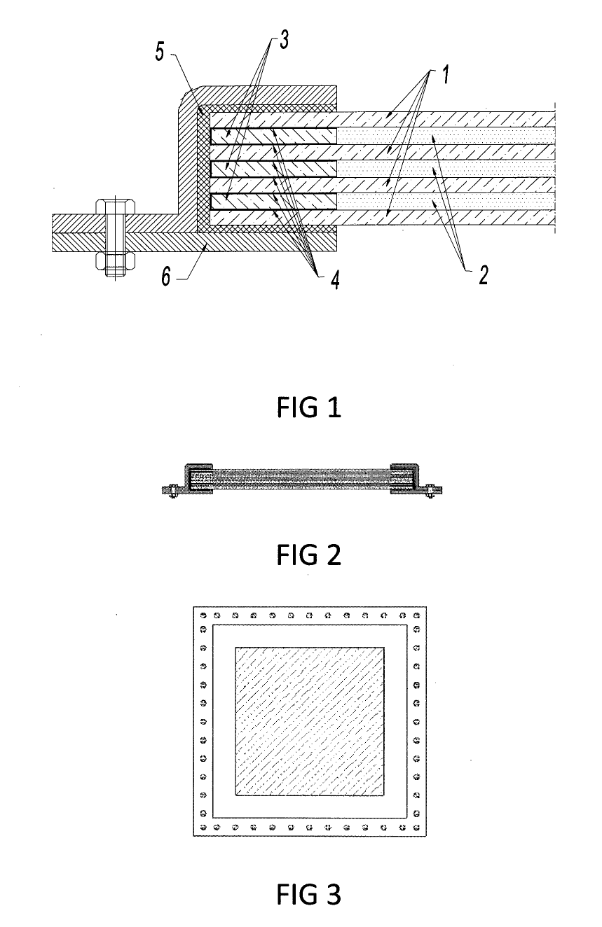

### DESCRIPTION

### Filed of the Invention

The present invention relates to the glazing unit for underwater objects of high strength obtained by the separation of successive layers of mineral glass pane by layers of very low compressible liquid, intended for windows separating different pressure environment particularly to underwater object.

### Description of the Prior Art

Marine constructions regulations permit for underwater windows only glass made of acrylic materials. Windows made of acrylic materials are formed in monolithic block with high thickness and weight.

Known in the prior art mineral multilayered glass build of mineral pane layers adhesive together with PVB film or different adhesives means. This kind of multilayered glass construction is used as safety glass (anti-theft, bullet-proof), which resistance is limited by resistance of single pane layer. Adhesives means used in known constructions have low shear strength, what cause that two adhesive pane layers do not provide monolithic construction in the case of rupture of the adhesive layer.

Document PL337959 discloses curved, transparent laminar screen consists of at least two solid screen sections and an intermediate multi-layered laminate composed of at least one carrier film with outer adhesive layers. The visible surface of the laminar screen has an opaque edge strip on at least one side. The carrier film, extending over visible surface has its edge is just covered by the edge strip.

Document PL92110 discloses unity model of multilayered glassy composite designated to formed a new type of frameless window for construction consisting of gluing several glass thought circumferential spacers placed on circuit edge between glass and subsurface spacers placed in two space inside between panes on the top and above border circumferential spacer. Multilayered glassy composite has two ports located in points corresponding to middle of subsurface spacers.

Document PL 172011 discloses glassy composite consist of set of two panes glass fastening permanently trough transparent spacer with inner vacuum cavities.

Document PL 312930 discloses glassy composite which glazing unit consists of bland film paste gluing to aluminum frame by silicone-based adhesive with 1-2 mm diameter inlet. Between panes there is divided by film gas space. On panes borders and frames on whole circuit there is sealing and frames are filled with hygroscopic means.

Document PL 190583 discloses a glassy composite comprises two sheets of glass separated by a layer of transparent plastic material, capable of sticking to glass, of greater thickness than the two sheets. The composite has a total thickness <5 mm, a ratio of thickness of plastic to thickness of glass sheets of 1-10, a surface mass <6 kg/m<2>, and a Young modulus >30 Gpa for a total thickness of 3 mm. Also claimed are a process for determining optimum geometric parameters for the composite and a product made from it.

Document PL 206995 discloses a glassy composite, method of manufacturing therefore and profiled strip insert the glassy composite. Glassy composite comprises at least two glass sheets separated by a gas layer, an interlayer for spacing apart the two glass sheets and having an inner surface opposite the gas layer and an opposite outer surface, and sealing means with respect to the inside of the glazing. The invention is characterized in that the interlayer is in substantially flat form flat with encloses the periphery of the glazing by being pressed by its inner surface against the edges of the glass sheets, and maintained fixed by securing means

Document PL 378827 discloses glassy composite, consists of set of at least two parallel panes. Between every pair of panes there is close profile structural frame filled with desiccant. Between contact area frame—panes there is a layer of primary sealing. Panels of frames are permeable and outer cavity between panes border is filled with secondary sealing. Outer frame surface closing outer cavity outer cavity between panes border have additional primary sealing layer.

### SUMMARY OF THE INVENTION

The substance of the invention is a glazing unit suitable for underwater objects windows consisting of panes of mineral glass placed in circumferential clamp ring and on borders between panes of mineral glass have circumferential spacers, which have sealing in contact area with pane of mineral glass, characterized in that glazing unit have at least two panes of mineral glass separated by a layer of low compressible liquid, while constructed set of panes of mineral glass with circumferential spacers and sealing are border with circumferential seal clamped by circumferential clamp ring. Favourably thickness of liquid layer located between panes of mineral glass is equal to panes of mineral glass layer. Favourably spacers are made of mineral glass.

The presented invention solution allow to gain construction of multilayered pane of glass with high strength and mechanical damage resistance. Strength construction by invention is obtain by separation successive layers of mineral glass panes by very low compressible liquid layers, enable accurate strength calculation by verified calculation method e.g. MES for thin panes. Construction of multilayered pane of glass where every layer is individual strength component, by using appropriate safety factor in case damages of one or several layers is still effective barrier separating different pressure environment.

Invention provide high abrasion resistance of surface, so mineral glass do not tarnished during cleaning particular cleaning in order to disposal microorganism from external surface of underwater object windows.

Mineral glass used in multilayered pane is material with good optical characteristic. Mineral glass does not deform the outside view form underwater object. Made by invention glazing unit is able to transfer load causing by differential pressure on both sides. From the higher pressure side work uniformly loading whole surface of glass pane forces. Applied on outer surface of glass pain forces cause stresses, which through low compressibility liquid are transmitted on successive layer of glass pane. In that way all glass pane layers are loaded proportionately.

Layers of glass pane on borders are divided by band of mineral glass additionally faced with flat sealing. This solution lead seals cavity between panes as well transfer load from whole surface of pane on windows frame. Used here a high compression of glass resistance. Applied flat seals enable freely sliding layers of glass pane relative to each other due to slight shaft deflections. The possibility of moving reduced the unfavorable glass stress on the edges.

Shown above multilayered pane of mineral glass construction could be used in flat and moulded panes.

### BRIEF DESCRIPTION OF THE DRAWINGS

The invention subject is shown in the drawing 1/3 presents in a part of cross-section joints of multilayered panes clamped by clamp ring, 2/3 presents multilayered panes joints clamped by clamp ring in cross-section, 3/3 presents multilayered panes joints clamped by clamp ring in top view.

### DESCRIPTION OF THE PREFERRED EXECUTION

### Execution Example I

Glazing unit suitable for underwater objects windows consisting of panes of mineral glass placed in circumferential clamp ring and on borders between panes of mineral glass 1 have circumferential spacers 3 made of mineral glass, which have in contact area with pane of mineral glass 1 sealing 4. Glazing unit have two panes of mineral glass 1 separated by a layer of low compressible liquid 2. Constructed set of panes of mineral glass 1 with circumferential spacers 3 and sealing 4 are border with circumferential seal 5 clamped by circumferential clamp ring 6.

### Execution Example II

Glazing unit suitable for underwater objects windows consisting of panes of mineral glass placed in circumferential clamp ring and on borders between panes of mineral glass 1 have circumferential spacers 3 made of mineral glass, which have in contact area with pane of mineral glass 1 sealing 4. Glazing unit have two panes of mineral glass 1 separated by a layer of low compressible liquid 2. Thickness of liquid layer 2 located between panes of mineral glass 1 is equal to panes of mineral glass 1 layer. Constructed set of panes of mineral glass 1 with circumferential spacers 3 and sealing 4 are border with circumferential seal 5 clamped by circumferential clamp ring 6. Spacers 3 are made of mineral glass.

1. Glazing unit suitable for underwater objects windows comprising panes of mineral glass placed in circumferential clamp ring and on borders between panes of mineral glass have circumferential spacers, which have sealing in contact area with pane of mineral glass characterized in that, glazing unit have at least two panes of mineral glass (1) separated by a layer of low compressible liquid (2), while constructed set of panes of mineral glass (1) with circumferential spacers (3) and sealing (4) are border with circumferential seal (5) clamped by circumferential clamp ring.

2. Glazing unit, according to claim 1, wherein thickness of liquid layer (2) located between panes of mineral glass (1) is equal to panes of mineral glass (1) layer.

3. (canceled)

4. Glazing unit, according to claim 1, wherein spacers (3) are made of mineral glass.
